(19) United States
(12) Patent Application Publication
(10) Pub. No.: US 2007/0292232 A1
(43) Pub. Date: Dec. 20, 2007

(54) Nut having cutting and fastening structure thereof

(75) Inventors: Arthur Chang, Taipei (TW); Fu-Ming Chen, Taipei (TW)

Correspondence Address: BIRCH STEWART KOLASCH & BIRCH, PO BOX 747, FALLS CHURCH, VA, 22040-0747, US

(73) Assignee: ASUSTeK COMPUTER INC.

(21) Appl. No.: 11/790,863

(22) Filed: Apr. 27, 2007

(30) Foreign Application Priority Data
Jun. 20, 2006 (TW) 95122144

(51) Int. Cl. F16B 39/12

(52) U.S. Cl. 411/240

(57) ABSTRACT

A nut having a cutting and fastening structure thereof applied to fasten at least a board with a hole are disclosed. The nut has at least a cutting through itself. The fastening structure includes a bolt and a nut. When the nut is threaded on the bolt, the cutting of the nut and threads of the bolt touch each other for increasing the friction.

### FIELD OF THE INVENTION

The present invention generally relates to a nut, more particularly to a nut having cutting of a fastening structure.

### DESCRIPTION OF THE RELATED ART

With the electronic technology vigorous development, all kinds of electronic components are applied to make up the electronic apparatus. Bolts and nuts are extensively used to join the electronic components. But, once bolts and nuts did are not tightened tightly, the electronic apparatus may malfunction.

Please refer to FIG. 1, which illustrates a schematic exploded view of a fastening structure of the bolt and the nut in prior arts. The fastening structure 10 includes a bolt 11, an upper board 12, a lower board 13, a spacer 14, and a nut 15. There are through holes 121, 131 for receiving the bolt 11 individually on the upper board 12 and the lower board 13. The nut 15 is threaded on the bolt 11 for forcing the upper board 12 and the lower board 13 together. The spacer 14 is placed between the hole 121 and the nut 15 to increase the friction between the nut 15 and the upper board 12 so as to prevent the nut 15 falling off or loosing.

The above conventional fastening structure does not have good effect for preventing the nut movement. The friction area between the spacer and the nut is not large enough, and the friction effect produced from threads of the bolt and the nut is limited. Therefore, the nut of conventional fastening structure may be easily fall off or loose.

So, how to find an improved fastening structure to resolve the drawbacks of the prior art is an important issue for the persons skilled in the art.

### SUMMARY OF THE INVENTION

The objective of the present invention is to provide a nut having a cutting for increasing surface friction force and a fastening structure.

In accordance with the present invention, a nut with a cutting cooperates with a bolt to fasten a board is provide. The nut has at least one cutting.

In one aspect of the present invention, the cutting of the nut upwardly extends from the bottom of the nut. The length of the cutting may be in the range of a quarter to two-thirds of the length from the bottom to the top of the nut. The outer surface of the bolt has a plurality of threads, the cutting of the nut and the threads of the bolt touch each other when the nut is threaded on the bolt.

In another aspect of the present invention, the nut has at least one cutting. The inner surface of the nut has a plurality of threads, called inner threads. The inner threads cooperate with the plurality of threads of the bolt. The cutting may be essentially parallel to the inner threads, and the length of the cutting may be in the range of a quarter to one and half of the length of a circumference of the nut.

### BRIEF DESCRIPTION OF THE DRAWINGS

Other features and advantages of this invention will become more apparent in the following detailed description of the preferred embodiments of this invention, with reference to the accompanying drawings, in which:

FIG. 1 illustrates a schematic exploded view of a fastening structure of the bolt and the nut in prior arts;

FIG. 2a illustrates an exploded view of a fastening structure of a first preferred embodiment of the present invention;

FIG. 2b illustrates a bottom plan view of a nut of the FIG. 2a;

FIG. 2c illustrated a cross-section view of the fastening structure of the first preferred embodiment of the present invention; and

FIG. 3 illustrates an exploded view of a second preferred embodiment of the nut having a cutting of the present invention.

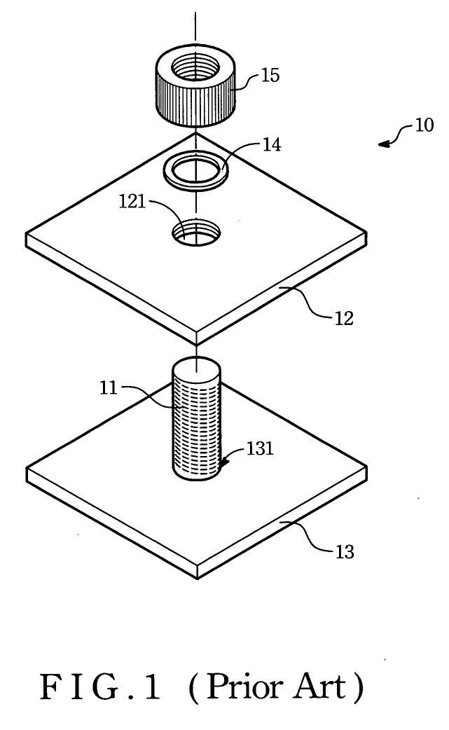

### DETAILED DESCRIPTIONS OF THE PREFERRED EMBODIMENTS

The preferred embodiment of the present invention discloses a nut with a cutting. The cutting reduces the contacting areas of a nut and a bolt so as to increase the friction force between the contacting areas.

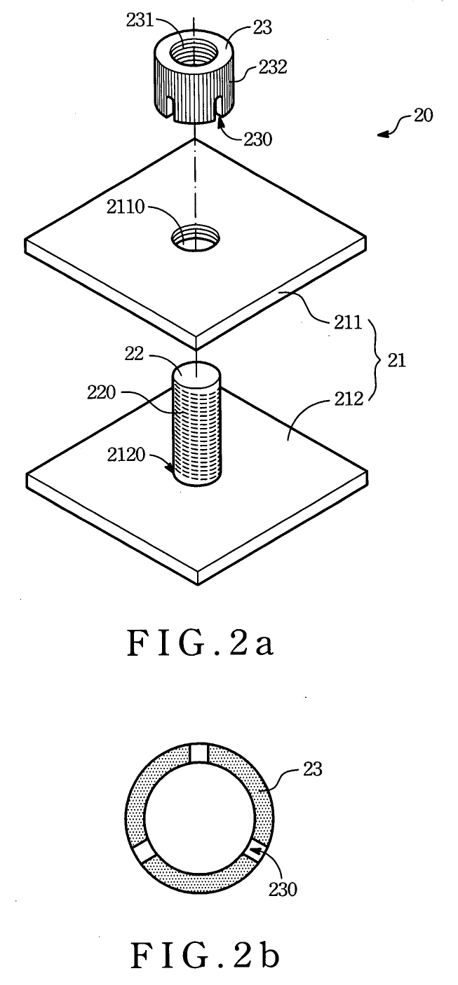

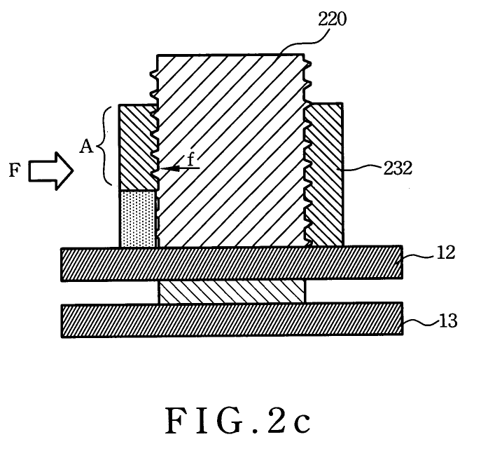

Referring to FIG. 2a and FIG. 2b, FIG. 2a illustrates an exploded view of a fastening structure of a first preferred embodiment of the present invention. The fastening structure is applied to fix a board 21. FIG. 2b illustrates a bottom plan view of a nut of the FIG. 2a. A fastening structure 20 has a bolt 22 and a nut 23. As shown in FIG. 2a, the board 21 has an upper board 211 and a lower board 212, the upper board 211 and the lower board 212 individually have holes 2210, 2120. The bolt 22 passes through holes 2120, 2110, and the peripheral surface of the bolt 22 has a plurality of threads 220. The nut 23 is threaded on the bolt 22 and the threads 220 of the bolt 22 matches up the inner threads of the nut 23, thereby fastening the upper board 211 with the lower board 212.

The nut 23 has a plurality of the cuttings 230, and upwardly extends from the bottom thereof, wherein the cuttings 230 are symmetrically set around the center of the nut 23. While the nut 23 combines with the bolt 22, there is a friction force between the cuttings 230 and the threads of the bolt 220.

The fastening structure of the first preferred embodiment not only has the fixing function, but also has the functions of preventing loosing or falling by the structure of the nut 23 having the plurality of cuttings 230.

The nut 23 is a hollow structure, and the inner surface 231 of the nut has a plurality of the threads. The threads on the inner surface 231 of the nut and the threads 220 may increase the friction force between the contacting areas to thread the nut on the bolt securely while the nut 23 female-connects the bolt 22. The outer surface 232 of the nut 23 has a plurality of small vertical grooves. Each of the cutting 230 is formed by vertically cutting the bottom of the nut 23.

As shown in the figures, the cutting 230 is through the inner surface 231 of the nut 23 and the outer surface 232 of the bolt 22, and extends from the bottom to the top of the nut 23. For the preferred embodiment as shown in FIG. 2b, three cutting 230 are fabricated on the nut 23. The length of each cutting 230 of the nut 23 is in the length of around a half of the length from the bottom to the top of the nut 23.

Referring to FIG. 2c, which illustrated a cross-section view of the fastening structure of the first preferred embodiment of the present invention. Assuming the applied force F is a fixed value, the smaller accepted area A, the greater pressure N per unit area, that is, the equation of N=F/A. The friction is defined as the motion resistance between two contacting surfaces of two corresponsive moving objects. The friction f is equal to the product of the friction factor μ and the pressure N vertical to the accepted area, that is, the equation of f=μN. It shows that the cutting can reduce the contacting area of the nut and the bolt, then increases the upright force of both touched area and the friction force.

Additionally, the inner surface 231 of the nut 23 in the embodiment is a circle or other arbitrarily form with the bolt 22, and the outer surface 232 of the bolt 22 can be a circle as well. Other embodiments for the outer surface 232 of the bolt 22 can be a square or hexagon figure. When the nut 23 downward rotates or presses into the bolt 22, the cuttings 230 and the threads 221 of the bolt 22 are wedged each other and then a friction force is generated so as to stabilize the combination of the bolt 22 and the nut 23.

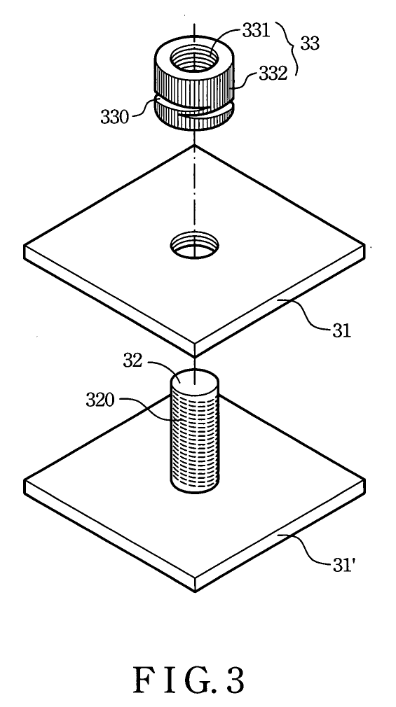

Referring to FIG. 3, which illustrates an exploded view of a second preferred embodiment of the nut having a cutting of the present invention. The nut 33 fastens two boards 31 and 31′ and a bolt 32, wherein the bolt 32 is through above boards 31 and 31′ and combines with the nut 33. The fastening structure in the second embodiment is similar to the first embodiment, but the cutting of the nut 33 is different. The cutting of the nut 33 in the second embodiment is described as follows.

The nut 33 in the embodiment has an inner surface 331 of the nut 33, an outer surface 332 of the bolt 32, and at least one cutting 330. The nut 33 is a hollow structure. The inner surface 331 of the nut 33 has a plurality of threads, which contacts a plurality of threads 320 of the bolt 32 to generate a friction force. The outer surface of the nut 332 of the nut 33 has a plurality of small vertical grooves. As shown in the figure, the cutting 330 is transversely cut through the inner surface 331 of the nut 33 and the outer surface of the nut 332. The cutting is about equal to these inner threads of the nut 33, and transversely cuts the inner surface 331 of the nut 33 and the outer surface 332 of the bolt 32. The cutting length of the cutting may be near to one circumference, a half circumference or one-thirds circumference of the nut 33. For the embodiment, there are two half circumferences of the cuttings 330 surrounded the nut 33, and the two cuttings 330 are discontinuous. By means of the cuttings, the bolt 32 and the nut 33 are tightly fastened each other.

Besides, the inner surface 331 of the nut 33 in the embodiment is a circular or other arbitrary form to match up the bolt 32. The outer surface 332 of the bolt 32 can be a circular as well. Other embodiments for the outer surface 332 of the bolt 32 can be a square or a hexagon. With the nut 33 getting into the bolt 32, the nut 33 downward rotates and presses into the bolt 32, the cuttings 330 and the threads 320 of the bolt 32 are wedged each other. Then, a friction force is generated so as to stabilize the combination of the bolt 32 and the nut 33.

As a conclusion, the plurality of cuttings are able to increase the fastening force of the bolt and the nut directly, and secondly the life of the bolt and the nut may be longer.

What is claimed is:

1. A fastening structure for fastening a board with a hole, comprising:
a bolt applied to pass through the hole, the outer surface of the bolt having a plurality of the threads; and
a nut having at least a cutting and being able to cooperate with the bolt to fasten the board, wherein the cutting of the nut and the threads of the bolt touch each other when the nut is threaded on the bolt.

2. The fastening structure according to claim 1, wherein the cutting of the nut upwardly extends from a bottom to a top of the nut.

3. The fastening structure according to claim 2, wherein the length of the cutting is in the range of a quarter to two-thirds of the length from the bottom to the top of the nut.

4. The fastening structure according to claim 1, wherein an inner surface of the nut has a plurality of threads, and the cutting of the nut bolt is essentially parallel to the threads.

5. The fastening structure according to claim 4, wherein the length of the cutting is in the range of a quarter to one and half of a circumference of the nut.

6. The fastening structure according to claim 1, wherein the nut has the plurality of cuttings, and the cuttings are disposed symmetrically comparative to the center of the nut.

7. The fastening structure according to claim 6, wherein the cuttings are not connected each other.

8. A nut with at least one cutting for cooperating with a bolt, characterized in that the nut has at least a cutting through itself.

9. The nut according to claim 8, wherein the cutting of the nut upwardly extends from a bottom to a top of the nut.

10. The nut according to claim 9, wherein the length of the cutting of the nut is in the range of a quarter to two-thirds of the length from the bottom to the top of the nut.

11. The nut according to claim 8, wherein the outer surface of the bolt has a plurality of the thread, while the nut is threaded on the bolt, the cutting and the threads touch each other.

12. The nut according to claim 8, wherein the inner surface of the nut has a plurality of threads, and the cutting of the nut is parallel to the threads of the nut.

13. The nut according to claim 8, wherein the length of the cutting is in the range of a quarter to one and half of a circumference of the nut.
